(19) United States
(12) Patent Application Publication
(10) Pub. No.: US 2006/0028791 A1
(43) Pub. Date: Feb. 9, 2006

(54) Mobile computer and peripheral device arrangement

(75) Inventors: Chao-Ming Huang, Taipei City (TW); Wen-Chieh Wang, Banciao City (TW); Ching-Jou Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/909,289

(22) Filed: Aug. 3, 2004

(51) Int. Cl. G06F 1/16

(52) U.S. Cl. 361/683; 361/681; 361/680

(57) ABSTRACT

A mobile computer and peripheral device arrangement includes a mainframe for a mobile computer, the mainframe having a recessed expansion slot in the bottom face near the peripheral back side thereof and retaining elements provided in the border area of the expansion slot, the expansion slot having two parallel guide rails at two sides, and an peripheral device detachably attached to the expansion slot in flush with the mainframe, the peripheral device having two guide grooves adapted to receive the guide rails of the expansion slot and to guide the peripheral device in and out of the expansion slot, and hooks adapted to engage the retaining elements of the mobile computer and to further lock the peripheral device to the expansion slot.

### BACKGROUND OF THE INVENTION

1. Field of the Invention

The present invention relates to an expansion slot for a mobile computer and, more specifically, to a mobile computer and an peripheral device arrangement in which an expansion slot is formed in the mobile computer, for example, a Tablet PC to accommodate an peripheral device.

2. Description of Related Art

For the advantages of high mobility and cordless attachment of peripheral devices, mobile computers (including notebook computers and tablet PCs) have been intensively used to substitute for desk computers.

A Tablet PC is one of the most rapidly developing products in recent times as it provides the features of handwriting input, digital ink, etc. However, due to market trends toward lighter, thinner, shorter, and smaller designs, a tablet PC may selectively sacrifice some peripheral devices, for example, the keyboard. Some peripheral components like earphone or a network cable, on the other hand, are only useful when attached to the mainframe, and these peripheral components may be lost easily or not readily at hand when separated from the mainframe.

Further, in order to reduce the size and the weight, the mainframe of a tablet PC cannot receive many adapters, and a port replicator or the like should be introduced in order to connect to an external peripheral device such as a LCD projector. Furthermore, the flat panel design of tablet PC does not allow the user to adjust the viewing angle like a notebook computer, thereby causing some inconveniences.

Therefore, it is desirable to provide a mobile computer and an peripheral device arrangement that eliminates the aforesaid problems.

### SUMMARY OF THE INVENTION

It is the main object of the present invention to provide a mobile computer and an peripheral device arrangement, which enables a peripheral device to be conveniently carried with the mainframe.

It is another object of the present invention to provide a mobile computer and an peripheral device arrangement, which enables easy expansion for a mobile computer.

To achieve these and other objects of the present invention, the mobile computer and a peripheral device arrangement (expansion slot) comprises a mainframe for a mobile computer, said mainframe having a top face, a bottom face, and four peripheral sides including a front side, a back side, and two opposite lateral sides, an expansion slot formed in the bottom face near said back side, and a first retaining means provided in a border area of the expansion slot, the expansion slot having a recessing face, two upright sidewalls, an upright front wall, and two first guide means respectively formed in the upright sidewalls; and a peripheral device detachably attached to the expansion slot, the peripheral device having a top face, a bottom face, a peripheral front side, two opposite peripheral lateral sides, two second guide means respectively formed in the two opposite peripheral lateral sides and adapted to slide with the first guide means of the expansion slot so as to guide the peripheral device in and out of the expansion slot, and second retaining means adapted to engage the first retaining means of the mobile computer so as to further lock the peripheral device to the expansion slot.

In short, the invention is to form an expansion slot in the back of the mobile computer for accommodating a peripheral device, which can be a keyboard, a storage box, an extension battery, or a port replicator. Subject to the requirement, any of a variety of peripheral devices can be selectively attached to the mainframe of the mobile computer for carrying by the user without increasing the size of the mobile computer.

### BRIEF DESCRIPTION OF THE DRAWINGS

FIG. 1 is an exploded view of a mobile computer and a peripheral device arrangement according to the first embodiment of the present invention;

FIG. 2 illustrates one application example of the first embodiment of the present invention;

FIG. 3 is an elevational view of a mobile computer and a peripheral device arrangement according to the second embodiment of the present invention; and

FIG. 4 is a side view showing an application example of the second embodiment of the present invention

### DETAILED DESCRIPTION OF THE PREFERRED EMBODIMENT

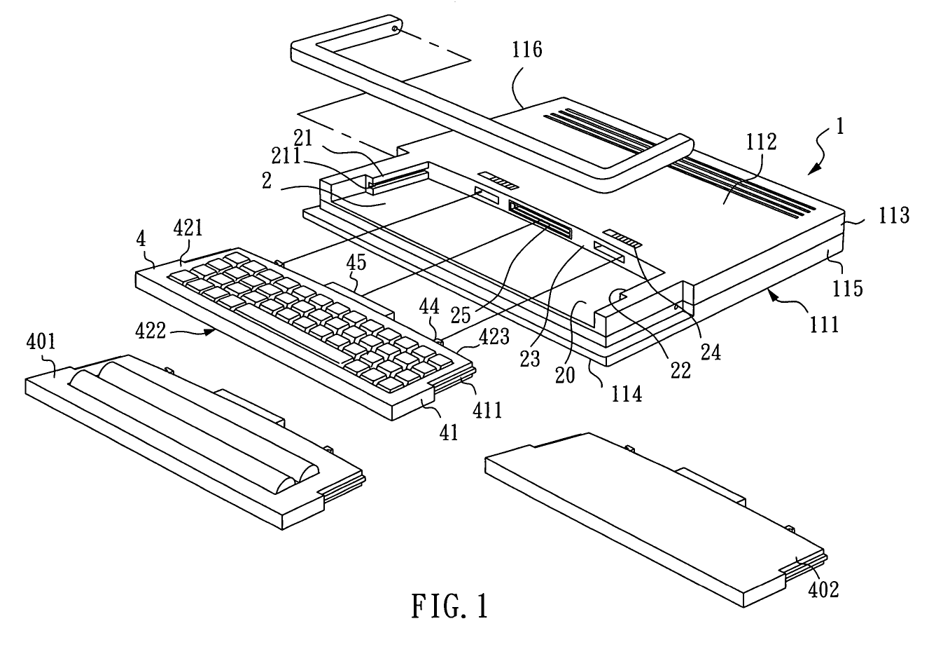

Referring to FIG. 1, a mobile computer and peripheral device arrangement in accordance with the first embodiment of the present invention is shown comprising a mainframe 1 for a mobile computer, for example, a Tablet PC. The mainframe 1 has a top face 111, a bottom face 112, and four peripheral sides, namely, the peripheral front side 113, the peripheral back side 114, and two opposite peripheral lateral sides 115 and 166. The bottom face 112 has a recessed area near the peripheral back side 114, forming an expansion slot 2. Resilient retaining elements (for example, release nodes) 24 are provided in the border area of the expansion slot 2. The expansion slot 2 is defined by a recessed face 20, two upright sidewalls 21 and 22, and an upright front wall 23. Two guide rails 211 are respectively formed in the upright sidewalls 21 and 22 and arranged in parallel. A keyboard 4 is detachably inserted into the expansion slot 2. The keyboard 4 has a top face 421, a bottom face 422, a peripheral front side 423, and two opposite peripheral lateral sides 41. The key switch array of the keyboard 4 is formed in the top face 421. Two guide grooves 411 are respectively formed in the two opposite peripheral lateral sides 41 and coupled to the guide rails 211 of the expansion slot 2. Hooks 44 are provided at the peripheral front side 423 of the keyboard 4. When inserting the keyboard 4 into the expansion slot 2, the hooks 44 are respectively forced into engagement with the resilient retaining elements 24 to lock the keyboard 4 to the expansion slot 2.

According to the present invention, the peripheral device is not limited to the keyboard 4. If the keyboard is not necessary, a detachable extension battery 401 may be used and inserted into the expansion slot 2 to extend the use time of the Tablet PC. Alternatively, a storage box 402 may be locked to the expansion slot 2 to house a network cable, sound source cable, modem cable, power cord, or any of a variety of accessories for the tablet PC.

Under certain conditions, the user may need to use an expansion slot that the Tablet PC does not provide, for example, a VGA-out, Com-port, or Parallel-port. In this case, a port replicator should be used. However, the use of a port replicator with a tablet PC occupies too much space and it is inconvenient to use/carry a Tablet PC with a port replicator. The expansion slot of the present invention can be a port replicator having a conventional expansion slot connector.

Further, in order to make the device light and simple, regular tablet PCs commonly adopt a 1-spindle design, i.e., the mainframe has only one hard diskdrive installed therein, and other apparatuses such as a CD-ROM player and floppy diskdrive are externally added. For the connection of an external apparatus, a female electrical connector 25 is formed in the upright front wall 23 of the expansion slot 2, and a male electrical connector 45 is provided at the peripheral front side 423 of the peripheral device, for example, the keyboard 4. Upon insertion of the peripheral device (the keyboard) 4 into the expansion slot 2, the male connector 45 is electrically connected to the female connector 25, allowing transmission of signals between the tablet PC 1 and the peripheral device (the keyboard) 4.

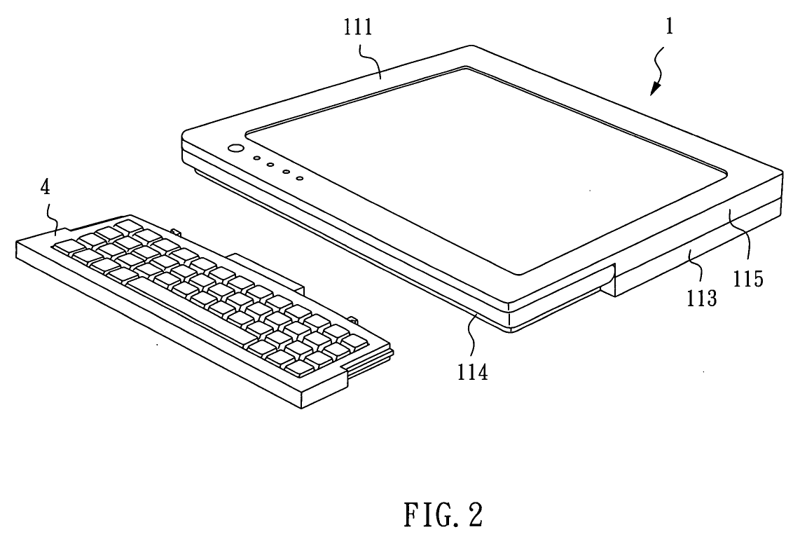

FIG. 2 is a schematic drawing showing an application example of the first embodiment of the present invention. As illustrated, the peripheral device is a keyboard. After removal of the keyboard 4 from the expansion slot of the tablet PC 1, the keyboard 4 can be operated to output signals to the tablet PC 1 by means of a wireless signal transmission method (for example, high-frequency radio or infrared ray). It is not imperative to transmit signals from the keyboard to the Tablet PC wirelessly. Alternatively, a keyboard cable may be used to electrically connect the keyboard to the tablet PC for signal transmission.

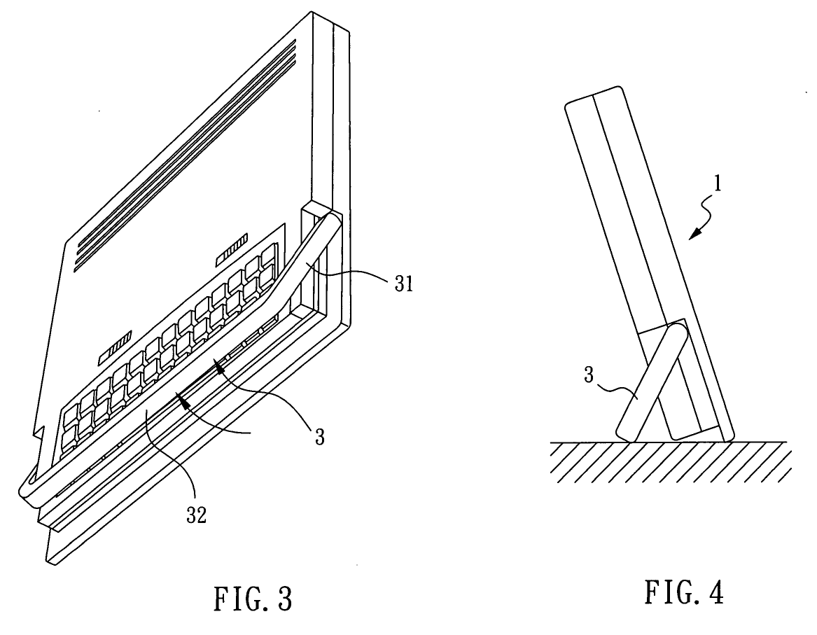

FIG. 3 is a schematic drawing of the second embodiment of the present invention. According to this embodiment, the tablet PC is equipped with a U-stand 3 on its backside. The U-stand 3 comprises two extension arms 31 and a support arm 32. The extension arms 31 each has one end respectively pivoted to the two opposite peripheral lateral sides of the tablet PC and the other end respectively fixedly connected to the two distal ends of the support arm 32. The U-stand 3 can be turned outwards from the tablet PC to support the it on a flat surface in a sloping position (see FIG. 4). By means of friction resistance, the U-stand 3 can prop the tablet PC in any position or one of a series of positions with a predetermined angle.

As indicated above, the mobile computer has an expansion slot adapted to accommodate a peripheral device without increasing the thickness of the mobile computer, and a pivoted stand for supporting the mobile computer on a flat surface in one of a series of sloping positions.

Although the present invention has been explained in relation to its preferred embodiments, it is to be understood that many other possible modifications and variations can be made without departing from the spirit and scope of the invention as hereinafter claimed.

1. A mobile computer and peripheral device arrangement comprising:
a mainframe for a mobile computer, said mainframe having a top face, a bottom face, and four peripheral sides including a front side, a back side, and two opposite lateral sides, an expansion slot formed in said bottom face near said back side, and a first retaining means provided in a border area of said expansion slot, said expansion slot having a recessed face, two upright sidewalls, an upright front wall, and two first guide means respectively formed in said upright sidewalls;
a peripheral device detachably attached to said expansion slot, said peripheral device having a top face, a bottom face, a peripheral front side, two opposite peripheral lateral sides, two second guide means respectively formed in the two opposite peripheral lateral sides and adapted to slide with said first guide means of said expansion slot so as to guide said peripheral device in and out of said expansion slot, and second retaining means adapted to engage the first retaining means of said mobile computer so as to further lock said peripheral device to said expansion slot, said peripheral device comprising a first electrical connector located on the peripheral front side; said expansion slot comprising a second electrical connector located on the upright front wall and adapted to receive the first electrical connector of said peripheral device; and
a stand adapted to support said mobile computer on a flat surface in a sloping position, said stand comprising two extension arms and a support arm, said extension arms each having a first end respectively pivoted to the two opposite lateral sides of said mainframe and a second end respectively fixedly connected to two distal ends of said support arm.

2-3. (canceled)

4. The mobile computer and peripheral device arrangement as claimed in claim 1, wherein said peripheral device is a CD-ROM player.

5. The mobile computer and peripheral device arrangement as claimed in claim 1, wherein said peripheral device is a floppy diskdrive.

6. The mobile computer and peripheral device arrangement as claimed in claim 1, wherein said peripheral device is an extension battery.

7. The mobile computer and peripheral device arrangement as claimed in claim 1, wherein said peripheral device is a storage box.

8. The mobile computer and peripheral device arrangement as claimed in claim 1, wherein said peripheral device is a keyboard.

9. (canceled)
